(19) United States
(12) Patent Application Publication
(10) Pub. No.: US 2006/0165498 A1
(43) Pub. Date: Jul. 27, 2006

(54) Cutting and shaping tool

(76) Inventor: Harald Ramfjord, Gjovik (NO)

Correspondence Address: Ronald R Santucci;Frommer Lawrence & Haug, 745 Fifth Avenue, New York, NY, 10151, US

(21) Appl. No.: 10/535,967

(22) PCT Filed: Dec. 12, 2002
(86) PCT No.: PCT/NO02/00475

§ 371 Date: Oct. 12, 2005

(51) Int. Cl. B26D 1/12

(52) U.S. Cl. 407/31

(57) ABSTRACT

A cutting tool especially for difficult accessible structures of materials such as steel, concrete, reinforced materials, carried preferably on and operated by a remote controlled vehicle, where the cutting tool comprises a C-shaped frame (1), the end of the first arm of the frame (1) comprising a rotation device (4), the end of the second arm comprising a mounting device (7), the rotation device (4) and the mounting device (7) being adapted to receive one end of a milling shaft (3) each, and to rotate the milling shaft (3) during operation, the frame (1) thereby being displaced towards the structure (5) one arm of which at each side of the structure, by a feeding mechanism (9) secured to an operating arm (8) on the vehicle.

The present invention is related to a cutting tool for especially difficult accessible structures of materials such as steel, concrete, reinforced materials.

In many cases steel structures are dismantled or parts are to be replaced, resulting in sections or parts of the structures be cut away. In many cases such cutting may be difficult due to bad accessibility and the environment under which the work has to be performed. Structures in the sea or at the sea bottom, in nuclear plants etc. are examples of such works which requires special skill and equipment to be performed.

It is essential that equipment used in such cases is flexible and easy to manoeuvre and operate. In cases where parts are to be cut away to be replaced, it is also essential that the cutting surfaces can be used more or less without further treatment, such as by welding. It is further an advantage that the equipment is able to cut several dimensions without having to replace the equipment or make essential modification on the equipment.

It is well known to use wires covered with diamonds to saw such structures by means of a cutting tool carried by a remote controlled vehicle. Even if such equipments ensure that the wire is kept tight, there are disadvantages connected with the principle of sawing by means of wires, especially in connection with the accuracy of the cuts as well as the space necessary for operating the vehicle with the cutting tool.

With the cutting tool according to the present invention, the above requirements are fulfilled and disadvantages by known method and equipment are avoided. This is achieved with the cutting tool according to the present invention as defined by the features stated in the claims.

The drawing discloses in

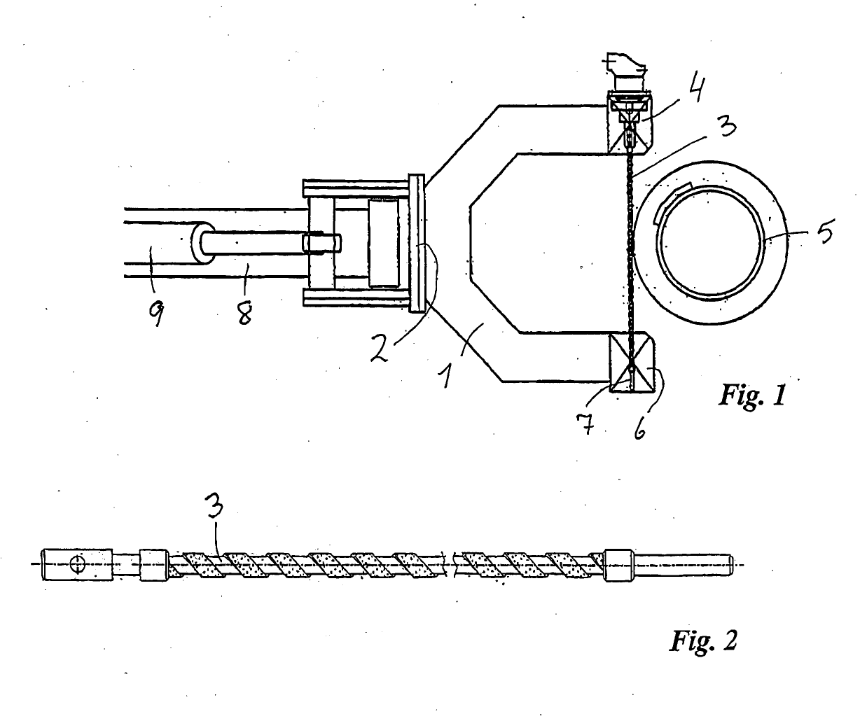

FIG. 1 schematically a ground plan of a cutting equipment in position against a structure to be cut and

FIG. 2 discloses a front view of one embodiment of a milling shaft.

The cutting tool according to the present invention is suitably mounted on a remote operated vehicle, enabling the cutting tool to operate in the sea, at the sea bottom as well as at difficult accessible places at sea or offshore, as well as in environments such as nuclear plants and environments with risk for explosion etc.

An operating arm 8 is mounted on the remote operated vehicle, adapted to be manoeuvred in all directions.

At the end of the operating arm 8, is located a connection frame 2 which can be displaced axially by an extension means, such as a feeding mechanism 9.

To the connection frame 2 is secured a support frame 1, the connection between the support frame 1 and the connection frame 2 enabling the support frame to be rotated to a desired position such as vertically, horizontally etc.

The support frame 1 has a C-shape, comprising two arms extending from the connection frame 2. The distance between the two arms decides the maximum dimension, such as diameter, of the structures to be cut. The distance between the two alms may be in the range of 0.5 or 1.5 m or larger.

At the end of one arm of the support frame 1, a rotation device 4 is secured, at the end of the other arm is secured a mounting device 7, a milling shaft 3 extending from the rotation device 4 to the mounting device 7.

The shape and surface of the milling shaft 3 may be chosen as being well suited for machining a structure of a material or a combination of materials in question. As such the milling shaft may be a solid rod provided with a surface adapted for machining respectively grinding of the structure.

The milling shaft 3 may be a solid and strong rod having minimum diameter related to the structure to be cut. The milling shaft 3 may comprise along the machining zone at least one grinding surface on at least parts of the shaft surface, said grinding surface(s) may comprise embedded diamonds, at least one helically shaped grinding surface, several spaced apart rings with grinding surfaces or such. Rings as mentioned may be connected with and captured by the milling shaft core by non-circular cross section of the ring interior and corresponding cross section of the core exterior, or other suitable means. The active grinding surface or surfaces of the milling shaft 3 may be easily replaceable, as may the milling shaft 3 as such.

One embodiment of a milling shaft 3 is disclosed in FIG. 2 and comprises one helically extending milling surface covered with artificial diamonds. By rotating the milling shaft 3 and activating the feeding mechanism 9, the milling shaft 3 will cut or grind into the structure 5, leaving a cutting surface which is smooth and straight. The forces from the milling shaft 3 to the structure 5 are very small, resulting also in small forces to be transferred from the milling shaft 3 to the remote controlled vehicle via the support frame 1.

To increase the efficiency of the cutting tool according to the present invention, the arms are provided with oscillating devices 6, providing the milling shaft 3 with a reciprocating movement in the axial direction of the shaft 3 in addition to the rotation. The oscillating displacement ensures that material from the milling operation is taken out of the cutting area and avoiding that the same spot of the milling shaft is exposed to abrasion over a too long period of time.

The securement of the milling shaft 3 to the rotation device 4 respectively the mounting device 7 is adapted for automatic replacement of the milling shaft 3 as the consumable tool, to ensure continuous operation, which is especially beneficial when operating the remote operated vehicle and the cutting tool at locations with limited or restricted access.

1. A cutting tool especially for difficult accessible structures of materials such as steel, concrete, reinforced materials, carried preferably on and operated by a remote controlled vehicle, wherein the cutting tool comprises a C-shaped frame (1), the end of the first arm of the frame (1) comprising a rotation device (4), the end of the second arm comprising a mounting device (7), the rotation device (4) and the mounting device (7) being adapted to receive one end of a milling shaft (3) each, and to rotate the milling shaft (3) during operation, the frame (1) thereby being displaced towards the structure (5) one arm of which at each side of the structure, by a feeding mechanism (9) secured to an operating arm (8) on the vehicle.

2. Cutting tool according to claim 1, wherein the arms being provided with oscillating devices (6) reciprocation the rotating milling shaft (3).

3. Cutting tool according to claim 1, wherein the milling shaft (3) comprises at least along the machining zone at least one grinding surface on at least parts of the shaft surface, said grinding surface(s) may comprise embedded diamonds, a helically shaped grinding surface, several spaced apart rings with grinding surfaces.

4. Cutting tool according to claim 2, wherein the milling shaft (3) comprises at least along the machining zone at least one grinding surface on at least parts of the shaft surface, said grinding surface(s) may comprise embedded diamonds, a helically shaped grinding surface, several spaced apart rings with grinding surfaces.
